(19) United States
(12) Patent Application Publication
(10) Pub. No.: US 2004/0014021 A1
(43) Pub. Date: Jan. 22, 2004

(54) Apparatus and method for evaluating school readiness

(76) Inventor: Iyad Suleiman, Nazareth (IL)

Correspondence Address: Reed Smith LLP, 29th Floor, 599 Lexington Avenue, New York, NY, 10022, US

(21) Appl. No.: 10/198,279

(22) Filed: Jul. 17, 2002

(51) Int. Cl. G09B 3/00

(52) U.S. Cl. 434/354; 434/323; 434/362

(57) ABSTRACT

A computer-based apparatus for evaluating school readiness of a child, based on challenging the child to play a series of games and automatic comparison of performance data of the child in these games with a database of performance results of a population of children. The apparatus comprises a server; storing facility provided on said server with database that comprises personal identity data and game performance parameters of the population and a games library. The games library comprises a plurality of games. The apparatus further comprises processor provided on said server for processing the child's performance data, comparing the performance data with the performance results of the population and evaluating the child using a genetic algorithm, and at least one of a plurality of computers that may be connected over a network to the server; the computer including a didactic navigator for recalling a game from the games library of the server and presenting it to the child on the display means, receiving through the user interface input from the child, and transmitting it to the processor of the server for analyzing.

### FIELD OF THE INVENTION

The present invention relates to apparatus and method for assessment school readiness. More particularly, the present invention relates to a computer-based apparatus and a computer-based method for evaluating school readiness and diagnosing learning disabilities.

### BACKGROUND OF THE INVENTION

Assessment of school readiness is a very important tool for evaluating the ability of children to adapt to school learning conditions and to adjust to hours of concentrating in school. There are several parameters that indicate school readiness such as motorics, visual memory, lingual development etc. The evaluation of school readiness nowadays is performed by examiners that examine a child using card indexing. One examiner can examine one child at a time and sometimes needs a few sessions in order to complete a comprehensive evaluation.

In western countries, about 15% of the children need evaluation and there is a demand to examine more children for school readiness and learning disabilities. There is indeed a need to evaluate children before school from two reasons, the first is the disruption to the child's progress itself if the child starts school in an early stage in which he is still not prepared to school and the second reason is the distraction to other children in the class and to the class progress due to participation of a child that is not ready for school. Due to the vast amount of evaluations, the service of evaluating children is made by commercial companies (in the United States, for example) or by the public educational system.

In order to withstand the load and the extra demand for evaluations of school readiness and learning disabilities without compromising high standards, a computerized system is required. A computerized system is adaptive to children of the 21^{st} century since they are familiar with educational softwares and computer games. More than one child can be examines in the same time and the examinations and results evaluations are performed on a uniform basis. Personal interference of the examiners is made in specific cases in which personal interference is indeed required so as to effectively use the skilled examiners.

### SUMMARY OF THE INVENTION

It is an object of the present invention to provide a unique computer-based method and apparatus for evaluating school readiness and learning disabilities based on a uniform basis.

It is another object of the present invention to provide a unique computer-based method and apparatus for evaluating school readiness and learning disabilities that is based on database that is constantly updated and is provided with self-learning software that cultivates the software and improves its reactions during the examination itself. The computer software is not merely statistic but it is provided with “artificial intelligence”.

It is yet another object of the present invention to provide a unique computer-based method and apparatus for evaluating school readiness and learning disabilities in which the reactions of the child being examined are online analyzed quantitatively and qualitatively while an examiner that is provided with an additional terminal can interfere when necessary during the examination.

It is thus provided in accordance with a preferred embodiment of the present invention a computer-based apparatus for evaluating school readiness of a child, based on challenging the child to play a series of games and automatic comparison of performance data of the child in these games with a database of performance results of a population of children, the apparatus comprises:

a server;

a storing means provided on said server, said storing means provided with database that comprises personal identity data and game performance parameters of the population and a games library comprised of a plurality of games;

processing means provided on said server for processing the child's performance data, comparing the performance data with the performance results of the population and evaluating the child using a genetic algorithm;

at least one of a plurality of computers having display means and user interface, each computer connected over a network to the server; the computer including a didactic navigator for recalling a game from the games library of the server and presenting it to the child on the display means, receiving through the user interface input from the child, and transmitting it to the processing means of the server.

Furthermore, in accordance with another preferred embodiment of the present invention, said network is a web such as an Internet.

Furthermore, in accordance with another preferred embodiment of the present invention, the didactic navigator recalls the games through a task monitor that monitors bugs in the programs.

Furthermore, in accordance with another preferred embodiment of the present invention, said plurality of games comprises games from a group of games such as mazes, puzzles, drawings, questions with multiple answers.

Furthermore, in accordance with another preferred embodiment of the present invention, each computer is connected to the server via a Tcp/Ip connection.

Furthermore, in accordance with another preferred embodiment of the present invention, each computer is transfers and receives information from a local database hosted on the server through a LAN connection.

Furthermore, in accordance with another preferred embodiment of the present invention, the child inputs data into said user interface through a computer keyboard connected to one of the plurality of computers.

Furthermore, in accordance with another preferred embodiment of the present invention, the child inputs data into said user interface through a computer mouse connected to one of the plurality of computers.

Furthermore, in accordance with another preferred embodiment of the present invention, the child inputs data into said user interface through a touch screen provided on one of the plurality of computers.

Furthermore, in accordance with another preferred embodiment of the present invention, each one of the plurality of computers is provided with a speaker that is adapted to deliver oral instructions regarding a game.

It is therefore further provided in accordance with yetr another preferred embodiment of the present invention, a computer-based method for evaluating school readiness of a child, based on challenging the child to play a series of games and automatic comparison of performance data of the child in these games with a database of performance results of a population of children, the method comprises:

providing a server;

providing a storing means on said server, wherein said storing means provided with database that comprises personal identity data and game performance parameters of the population and a games library comprised of a plurality of games;

providing a processing means on said server for processing the child's performance data, comparing the performance data with the performance results of the population and evaluating the child using a genetic algorithm;

providing at least one of a plurality of computers having display means and user interface, each computer connected over a network to the server; the computer including a didactic navigator for recalling a game from the games library of the server and presenting it to the child on the display means, receiving through the user interface input from the child, and transmitting it to the processing means of the server;

exhibiting one of the plurality of games on the display means;

challenging the child to play the game through the user interface and input results;

transferring the results to said processing means;

calculating a score for the game;

exhibiting another game from the plurality of games, the other game is chosen according to the score of a former game;

establishing the child's performance data using the genetic algorithm and based on a series of results from games that were played;

comparing the child's performance data with the performance results of the population;

updating the database with the results and personal identity data of the child.

Furthermore, in accordance with another preferred embodiment of the present invention, the score is calculated in accordance with his progress in previous played games.

In addition, in accordance with another preferred embodiment of the present invention, game performance parameters are selected from a group of parameters including an identification of the game, a level of the game, maximum number of trials that are available for the game and maximum and minimum times that is available for playing the game, how many times the examinee can ask for help, penalty points for wrong answer, benefit points for right answer, penalty for pressing a Help button, penalties for extending beyond the time limit of the game or exceeding the maximum trials, and benefit points that are added for finishing the game in less time than the minimum time that is available for the game.

### BRIEF DESCRIPTION OF THE FIGURES

In order to better understand the present invention, and appreciate its practical applications, the following Figures are provided and referenced hereafter. It should be noted that the Figures are given as examples only and in no way limit the scope of the invention as defined in the appending claims. Like components are denoted by like reference numerals.

FIG. 1 depicts a schematic illustration of an examination procedure in accordance with a preferred embodiment of the present invention.

FIG. 2 depicts a schematic illustration of a system comprising a database and an examination in accordance with a preferred embodiment of the present invention.

FIG. 3 depicts a schematic illustration of a didactic navigator interface in accordance with a preferred embodiment of the present invention.

FIGS. 4a-e depict several stages of progress in a drawing game in accordance with a preferred embodiment of the present invention.

FIG. 5 illustrates connections between a server and a database in accordance with a preferred embodiment of the present invention.

FIG. 6 illustrates the interaction of a didactic navigator with other components of the system in accordance with a preferred embodiment of the present invention.

### DETAILED DESCRIPTION OF THE INVENTION AND FIGURES

The present invention provides a unique method and apparatus for evaluating school readiness and learning disabilities that is based on a computerized system provided with self-adaptive software and on a constantly updated database. One of the concepts of the system is that learning abilities can be attained during a game while the child that is examined doesn't know that he is being tested; thus providing a friendly environment. The system evolves about the known Genetic Algorithm, which is an optimization method that was established in the 70's. Genetic Algorithms are a part of evolutionary computing, which is a rapidly growing area of artificial intelligence. Genetic algorithms are inspired by Darwin's theory about evolution. Basically, in Genetic Algorithms, a solution to a problem is represented as a genome (or chromosome). The Genetic Algorithm then creates a population of solutions and applies genetic operators such as mutation and crossover to evolve the solutions in order to find the best one.

The test engine is based on databases, on the ability of the tested child to receive instructions from an assessor, on communication and feedback from the games that he is actuating, and on activating logic as regard to the learning process.

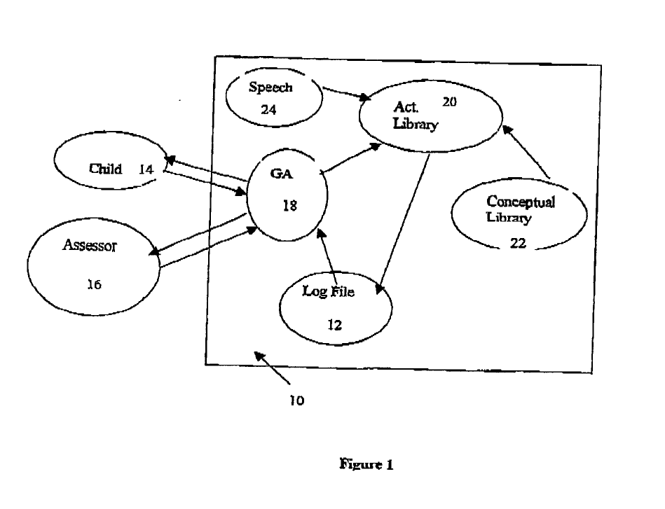

Reference is now made to FIG. 1, depicting a schematic illustration of an examination procedure in according with a preferred embodiment of the present invention. An interface 10 comprises a database 12 that includes information about the examinee and the game that is used for the evaluation. The assessor of the examination can insert part of this information into the computer. The information comprises parameters such as skill to test, the name of the game and its ID, the game's level, the maximum number of trials that are available for a game and the maximum and minimum times that is available for playing the game, how many times the examinee can ask for help, penalty points for wrong answer, benefit points for right answer, penalty for pressing a Help button, penalties for extending beyond the time limit of the game or exceeding the maximum trials, and benefit points that are added for finishing the game in less time than the minimum time. Any other parameters can be added as needed.

Database 12 is updated during the examination process from the interaction of the examinee with the games. Database 12 is an adaptive database in the sense that it is updated from the interaction of the examinee with the games and in the same time, the selection of the games and their parameters is performed according to the updated database. Two factors influence database 12: the examinee (the child) 14 and the assessor 16. Examinee 14 interacts with database 12 so that the database provides games according to the progress of the examinee. If the examinee fails to answer correct answers in regard to questions in a specific level, the database provides questions from a lower level. On the other hand, if the examinee shows high grades in his answers, the questions are picked up from a higher level. There is also a type of interaction between database 12 and assessor 16. Assessor 16 can view the exchange of information between database 12 and examinee 14 and is provided with an access to intervene and influence the exchange of information between the database and the examinee.

Database 12 provides information such as examinee number, game date, difficulty level, number of correct answers, number of wrong answers, solution time, how many times the examine asks for help, and calculated score to a Genetic Algorithm (GA) 18 that processes the information it receives from the database in order to establish an evaluation on the progress of examinee 14. As mentioned herein before, GA is inspired by Darwin's theory of evolution. The algorithm is based on the evolution of a number of arbitrary trials rather than on a logical process that is used in other algorithms. The GA starts with a set of solutions referred to as population that are represented by chromosomes. The solutions in one population serve to create a new population that is supposed to be better than the former population. The creator in the GA is an objective function named fitness function that checks the adaptation of each chromosome and its ability to survive. In each cycle, a crossover function is applied in order to choose two individuals for reproduction. The nest cycle is referred to as the offspring generation and the GA continues its iterations until a final condition is achieved. The mutations prevent the population from degeneration and help to find the optimal solutions. When a new population is being reproduced by crossover and mutation, there is a possibility to loose the best chromosome. In order to avoid this possibility, a method referred to as elitism is being employed. In this method, the best chromosome is being duplicated in the beginning of the process in order to enhance the GA. In order to establish an optimal GA, the parameters are being determined so that the crossover rate is between 80-95%, the mutation rate is between 0.5-1%, the population size is 20-30 and 50-100 can establish even better results, the selection can be established by roulette wheel selection or ranking and the pairing of the best chromosomes is done by elitism. The coding can be binary coding, values coding etc.

The GA uses the following information from the database: game ID, game level, skill to test, and the player's ID. The returned information from the GA is the next game to be played, the new level, the skill to test and the game score. An exemplary algorithm of a GA can be as follows:

1. [Start] Generating random population of n chromosomes x in the form of suitable solutions for the problem.

2. [Fitness] Evaluating the fitness f(x) of each chromosome x in the population.

3. [New population] Creating a new population by repeating the following steps until the new population is complete

1. [Selection] Select two parent chromosomes from a population according to their fitness (the better fitness, the bigger chance to be selected)

2. [Crossover] With a crossover probability cross over the parents to form a new offspring (children). If no crossover was performed, offspring is an exact copy of parents.

3. [Mutation] With a mutation probability mutate new offspring at each locus (position in chromosome).

4. [Accepting] Place new offspring in a new population.

4. [Replace] Using new generated population for a further run of algorithm.

5. [Test] If the end condition is satisfied, stop, and return the best solution in current population.

6. [Loop] Go to step 2

GA 18 provides also parameters to an activity library 20. Activity library 20 contains the exams and tests that are in the form of games. The games may include puzzles, mazes, drawings, paintings and so on. As mentioned herein above, Examinee 14 receives questions in the form of games so that he will not be intimidated by the exam process he is going through and secondly, children nowadays are very familiar with computer games so that the examinee usually relates with the computer in a positive manner. Activity library 20 receives information from a conceptual library 22 that contains questions in regard with terms such as before, after, small, large, tall, short, and so on. Activity library 20 also receives information from speech source 24 that provides the games with oral instructions that are provided to examinee 14 when needed. It should be noticed that the system is adapted for examining children before school (if used for school readiness evaluation), therefore, they have to receive oral instructions.

It has to be noted that one of the important features of the database incorporated in the present invention is that it is global in the sense that it contains information regarding many populations and their slicing as well as the adaptive nature of the games to a certain user and to a certain task or examination that the user has to go through. The database also updates on a regular basis from its different users (school readiness, learning disabilities), while the database collects information from every user that uses the system in order to update its information. In order for the database to be updated and use its global information during examination in an effective manner, the examination process is preferred to be performed over a web such as the Internet.

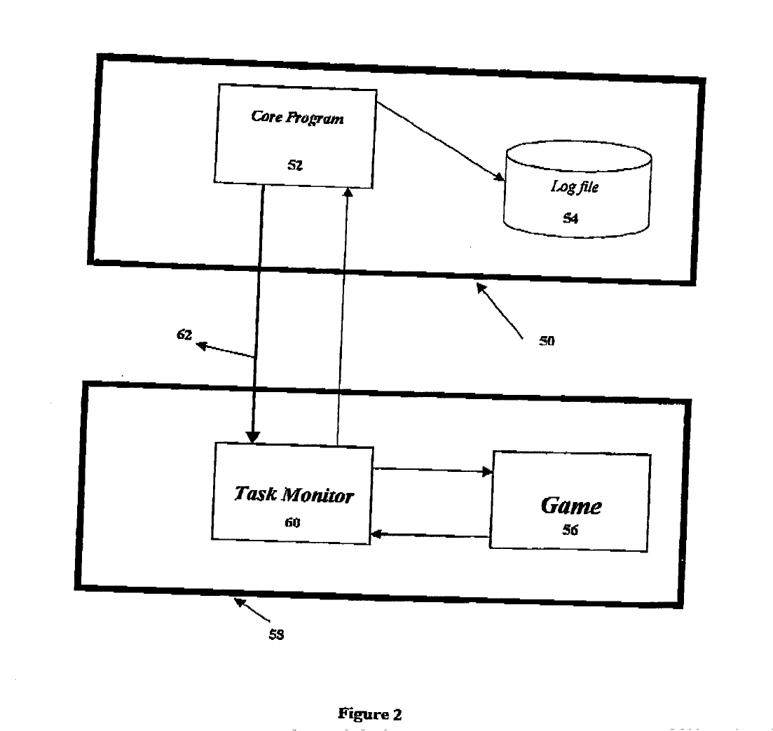

Reference is now made to FIG. 2 depicting a schematic illustration of a system comprising a database and an examination in accordance with a preferred embodiment of the present invention. Part of the system is hosted on a server 50. Server 50 is hosted on a web such as an Internet, an Intranet, or any other web that can serve a plurality of users. Server 50 is provided with a core program 52 that comprises the GA, the different libraries, and any other processing programs and game types programs that establishes the game and provides it to the user. Database 54 is also provided on server 50 so that all information that is contained or received by core program 52 and is relevant regarding updating the database is collected by database 54 in order to fulfill a complete and fully updated database.

A game 56 is preferably provided on a personal computer 58 that is positioned in learning centers, evaluation centers, schools, private houses, or any other facility that needs the assistant of such a system in order to evaluate school readiness, learning disabilities, and more. Game 56 interacts with a task monitor 60 that contains registration on every event that occurs in the game, between the examinee and the game and between the assessor and the game. Every question exhibited to the examinee as well as his answer is recorded on task monitor 60 and every interventions of the assessor on the game is also registered. In order to activate an updated game 56 that update database 54 during the examination, there should be an interaction between server 50 and personal computer 58. In order to establish the connection between the two, core program 52 is interacting with task monitor 60 through a two-way connection 62. The two-way connection is preferably a TCP/IP connection that is adapted to connect a number of different networks designed by different vendors into a network of networks (the “Internet”). In the system of the present invention, core program 52 sends information to task monitor 60 through two-way connection 62 using the Tcp/Ip protocol. The system then runs a specified game 56. Task monitor 60 connects immediately to core program 52 and sends information if it succeeded to run game 56, when the game is finished and how the game had been finished: normally or with runtime error.

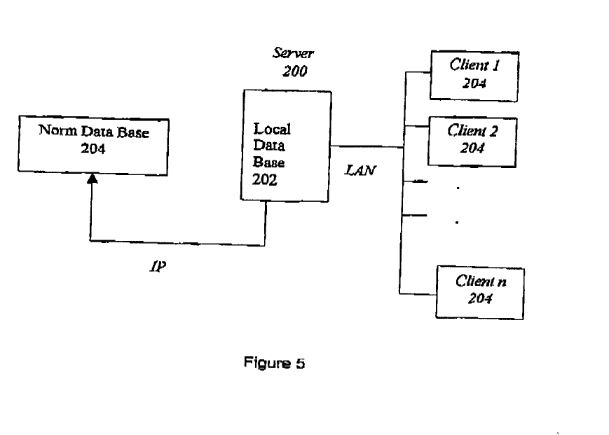

In order to clarify the concept of task monitor and its interaction with other components of the system, reference is now made to FIG. 5 illustrating connections between a server and a database in accordance with a preferred embodiment of the present invention. Server 200 is provided with a local database 202 that communicates through an IP connection with a norm database 204 that is the basic database of the system and includes all available information to be used by the software. Local data base 202 is connected by a LAN connection to at least one of a plurality of personal computers 204 that are used by clients using the system.

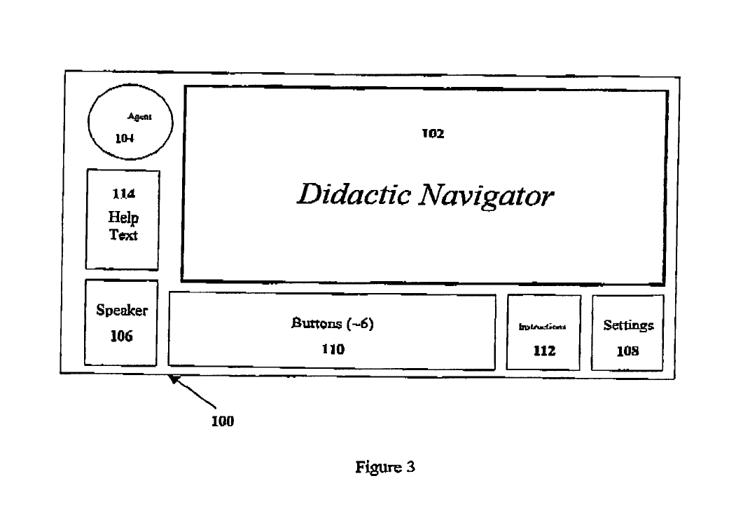

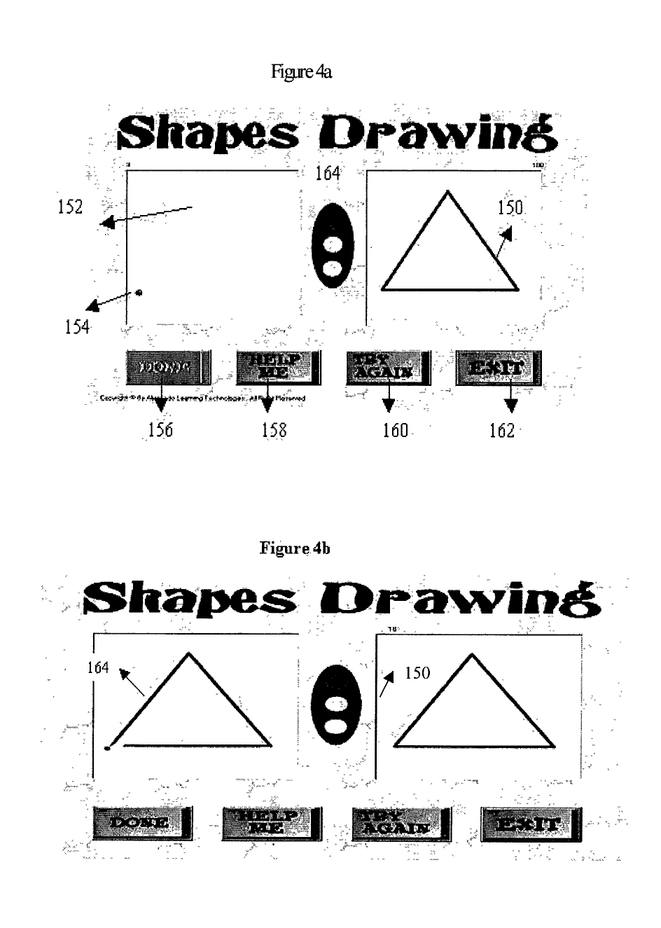

Reference is made to FIG. 3 depicting a schematic illustration of a game interface in accordance with a preferred embodiment of the present invention. A preferred game interface 100 comprises a didactic navigator 102 through which the games mentioned herein before can be activated. The games of didactic navigator 102 comprises questions and tests in the form of games such as puzzles, mazes, drawings, and so on. Interface 100 further comprises an agent 104 that can be in the form of a human character, a machine, a robot, an animal, or any other character that children can relate to. The character of agent 104 is positioned on the screen during the games or between the games and is adapted to provide guidance to the child user. The guidance may be by instructing the child before the game starts or during the game if there are difficulties, how to play or how to continue, to provide the child with compliments upon a success, or to provide the child with encouragement upon failing in a specific step of the game. Interface 100 is also provided with a speaker 106 that can be activated or deactivated according to the child user needs. Speaker 106 provides information regarding the game. The information can be also viewed on the screen if the child is able to read it; in this case, the speaker can be deactivated.

Interface 100 is further provided with settings 108 with which the child user or the assessor may change the scenery on the screen of the computer. The interface can be changed by changing the background of the screen, colors of writing, pictures, the agent character or any feature on the screen that may provide the child user with a friendly environment to work with in order to establish an optimizing corporation between the child user and the didactic navigator. The interface is also provided with buttons 110 through which the child user can transfer instructions to the interface. Buttons may be for starting the game, starting a new game, pausing the game, or continuing it. Instructions 112 to the child user on how to play the game, as mentioned herein, are also provided via interface 100.

In cases of problems related with the didactic navigator, a help text 114 is established and is exhibited on the didactic navigators screen.

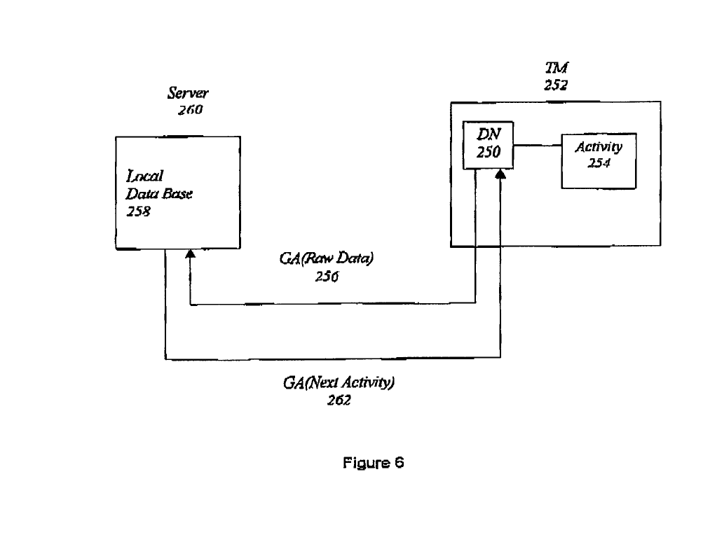

Reference is now made to FIG. 6 illustrating the interaction of a didactic navigator with other components of the system in accordance with a preferred embodiment of the present invention. Didactic navigator 250 is hosted on a task monitor 252, where it is connected ad interacts with a specific activity 254 or in other words a game that is shown to the child on the monitor. Raw data for the genetic algorithm 256 are transferred from didactic navigator 250 to local database 258 that is hosted on a server 260. After evaluation of the results from a previous activity, local database 258 transfers the next activity 262 to didactic navigator 250. Raw data 256 comprises data such as user ID, game ID, skill, activity, age, level, minimum playing time, maximum playing time, maximum requests for help, actual playing time, actual number of fails, actual number of requesting help button, click on exit button, click on solve button, maximum permitted times to play/try, success in the game, score, number of hits (different players), number of visits (the same player), locked, decreased points for exit, solve, failure, help etc., increased points for succeeding, actual time less than minimum time, and other parameters.

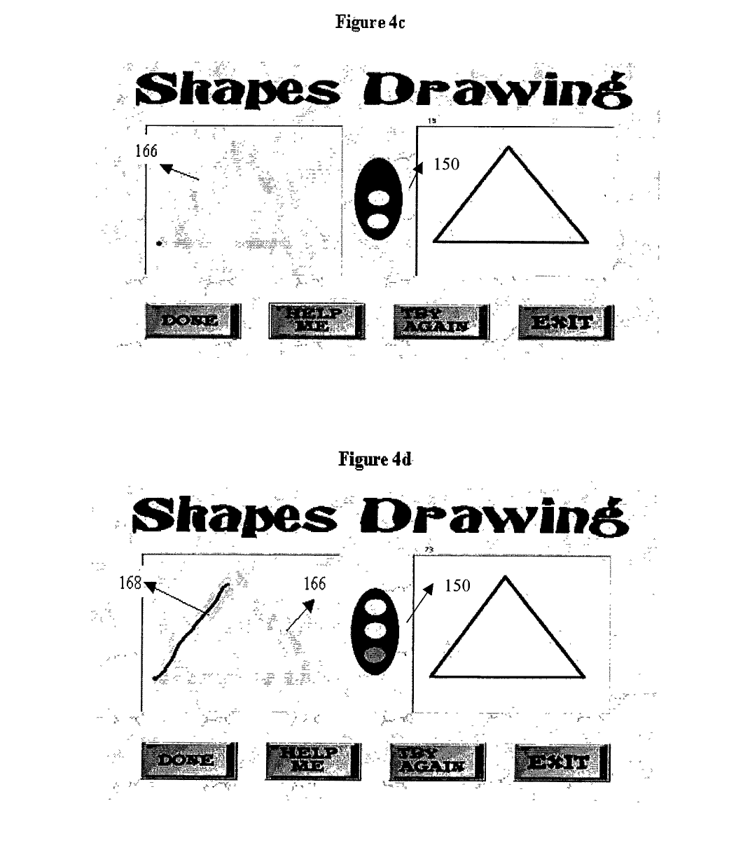

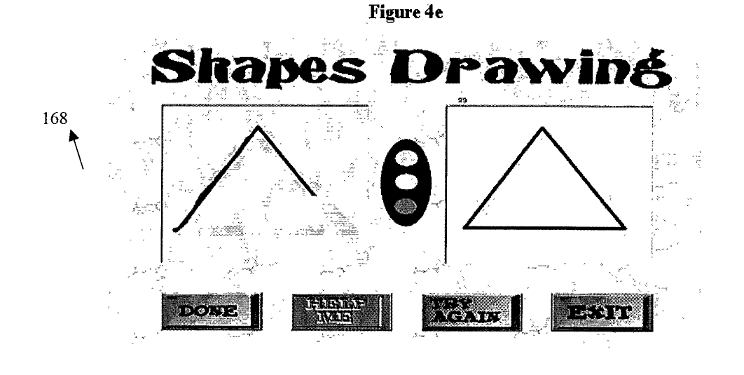

An example for a game is illustrated in FIG. 4. FIGS. 4a-e depict several stages of progress in a drawing game in accordance with a preferred embodiment of the present invention. FIG. 4a illustrates a start stage in a game in which shapes have to be drawn by the child user. The screen is divided in the following manner. In the right side, the shape to be drawn 150 is illustrated and in the left side, a space 152 in which the child has to draw the shape is located. A starting point 154 is also provided. On the bottom of the screen, a done area 156 is provided so that the child user presses this area when he is finished, a help area 158 is provided if the child user need help, try again area 160 is provided for the case the child fails to draw the shape and an exit area 162 is also provided. The screen also comprises a traffic light simulator 164 that indicate the child when to start and when to wait for the system to response. The child can get 100 points maximum score if he draws the shape correctly in the first try. The GA that is provided in the system calculates the score.

If the child cannot draw the shape correctly, and pushes help area 158, an illustration 164 of the shape is illustrates in space 152 as shown in FIG. 4b. After illustration 164 disappears, the child has to draw it again. If he fails and presses help area 158 again, the screen shown in FIG. 4b appears. Space 152 is shown with a gray background 166 that illustrates the shape to be drawn. This helps and guides the child to draw on gray background 166 the shape as shown by line 168. Finally, as shown in FIG. 4e, the child draws the shape.

The score of the child in this game is determined by his progress as follows:

t=(200−2nx)/(n(n−1)) where:

n is the number of attempts to choose help;

x is the first decreased point;

t is the current score.

It should be noticed that the game can be played by the user child in several ways: activation of a mouse, activating a keyboard, or activating a touch screen. Since parts of the system are adapted to children that are under school age, it is optional to provide a voice recognition system so that the child can answer some of the questions using his voice. Voice recognition systems are available and an example for such a system is disclosed in U.S. Pat. No. 5,991,726 where a voice recognition system that controls industrial equipment and machinery is provided. All these features can be incorporated in the game so as to establish a friendly environment for the child user and are covered by the scope of the present invention.

The system is founded in several levels so that the evaluation is a comprehensive one. In the case of school readiness evaluation, the evaluation includes the following fields:

Audio Perception

Visual-Motor Coordination

Cognitive Development

Visual Memory

Audio Memory

Verbal Development

Visual Perception

Motor Development

The evaluation that is established by the system of the present invention enables the assessor to maintain a comprehensive profile on the examinee while monitoring the following parameters: ranking the examinee according to the norm in every field; charts and diagrams of his results, details on errors of the examinee, details on the parameters that were incorporated in each of the games, and the details on the difficulty levels on which the examinee is working on.

The system can be used also as a basis for a school readiness system to be used at home by a child with the supervision of his parents, for example. The system is adapted to develop the learning abilities of the child user, again through a game. The system comprises a vast amount of games that cover fields of cognitive ability, knowledge and skills; the system is adapted to develop different learning skills through the games. The game's agent in the interface of the system enables the system to determine the different child abilities to be developed during the game according to the current abilities assessed by the system. Through the agent's interface, the level of difficulty is determined as well as the ratio between educational activities and activities having amusing character. An additional feature of the system is the ability to change the cultural characteristics of the games. The system is universal and is provided with multilingual software so that any child having a specific background is able to enjoy the games and to interact with the system. The system can be activated without a supervisor while the supervisor can withdraw a report on the activities and on the progress of the child user after the child finished to work. The progress report comprise a comprehensive profile on the child including leveling according to the norm in any field, in what filed the child is weak, in which field the child is strong, where he failed and where success was set.

It should be clear that the description of the embodiments and attached Figures set forth in this specification serves only for a better understanding of the invention, without limiting its scope as covered by the following claims.

It should also be clear that a person in the art, after reading the present specification could make adjustments or amendments to the attached Figures and above described embodiments that would still be covered by the following claims.

1. A computer-based apparatus for evaluating school readiness of a child, based on challenging the child to play a series of games and automatic comparison of performance data of the child in these games with a database of performance results of a population of children, the apparatus comprises:
a server;
a storing means provided on said server, said storing means provided with database that comprises personal identity data and game performance parameters of the population and a games library comprised of a plurality of games;
processing means provided on said server for processing the child's performance data, comparing the performance data with the performance results of the population and evaluating the child using a genetic algorithm;
at least one of a plurality of computers having display means and user interface, each computer connected over a network to the server; the computer including a didactic navigator for recalling a game from the games library of the server and presenting it to the child on the display means, receiving through the user interface input from the child, and transmitting it to the processing means of the server for analyzing.

2. The apparatus as claimed in claim 1, wherein said network is a web such as an Internet.

3. The apparatus as claimed in claim 1, wherein the didactic navigator recalls the games through a task monitor that monitors bugs in the programs.

4. The apparatus as claimed in claim 1, wherein said plurality of games comprises games from a group of games such as mazes, puzzles, drawings, questions with multiple answers.

5. The apparatus as claimed in claim 1, wherein each computer is connected to the server via a TCP/IP connection.

6. The apparatus as claimed in claim 1, wherein each computer is transfers and receives information from a local database hosted on the server through a LAN connection.

7. The apparatus as claimed in claim 1, wherein the child inputs data into said user interface through a computer keyboard connected to one of the plurality of computers.

8. The apparatus as claimed in claim 1, wherein the child inputs data into said user interface through a computer mouse connected to one of the plurality of computers.

9. The apparatus as claimed in claim 1, wherein the child inputs data into said user interface through a touch screen provided on one of the plurality of computers.

10. The as claimed in claim 1, wherein each one of the plurality of computers is provided with a speaker that is adapted to deliver oral instructions regarding a game.

11. A computer-based method for evaluating school readiness of a child, based on challenging the child to play a series of games and automatic comparison of performance data of the child in these games with a database of performance results of a population of children, the method comprises:
providing a server;
providing a storing means on said server, wherein said storing means provided with database that comprises personal identity data and game performance parameters of the population and a games library comprised of a plurality of games;
providing a processing means on said server for processing the child's performance data, comparing the performance data with the performance results of the population and evaluating the child using a genetic algorithm;
providing at least one of a plurality of computers having display means and user interface, each computer connected over a network to the server; the computer including a didactic navigator for recalling a game from the games library of the server and presenting it to the child on the display means, receiving through the user interface input from the child, and transmitting it to the processing means of the server;
exhibiting one of the plurality of games on the display means;
challenging the child to play the game through the user interface and input results;
transferring the results to said processing means;
calculating a score for the game;
exhibiting another game from the plurality of games, the other game is chosen according to the score of a former game;
establishing the child's performance data using the genetic algorithm and based on a series of results from games that were played;
comparing the child's performance data with the performance results of the population;
updating the database with the results and personal identity data of the child.

12. The method as claimed in claim 11, wherein the score is calculated in accordance with to the progress of the child in previous played games.

13. The method as claimed in claim 11, wherein said game performance parameters are selected from a group of parameters including an identification of the game, a level of the game, maximum number of trials that are available for the game and maximum and minimum times that is available for playing the game, how many times the examinee can ask for help, penalty points for wrong answer, benefit points for right answer, penalty for pressing a Help button, penalties for extending beyond the time limit of the game or exceeding the maximum trials, and benefit points that are added for finishing the game in less time than the minimum time that is available for the game.
